(19) United States
(12) Patent Application Publication
(10) Pub. No.: US 2016/0210256 A1
(43) Pub. Date: Jul. 21, 2016

(54) MOTHERBOARD AND ELECTRONIC DEVICE UTILIZING THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: ZHANG-LONG PENG, Wuhan (CN); CHUN-SHENG CHEN, New Taipei (TW)

(21) Appl. No.: 14/692,049

(22) Filed: Apr. 21, 2015

(30) Foreign Application Priority Data
Jan. 20, 2015 (CN) 201510027160.X

(51) Int. Cl. G06F 13/40; G06F 1/32; G06F 9/44

(52) U.S. Cl. CPC G06F 13/4022; G06F 9/4401; G06F 1/3287

(57) ABSTRACT

A motherboard applied in an electronic device includes a platform controller hub (PCH), a basic input and output system (BIOS), and a control circuit. The BIOS compares a temperature of the motherboard with a preset temperature in the BIOS, and controls the PCH to output a first control signal or a second control signal, according to a determined value. The control circuit controls a fan to operate or not operate, according to the first control signal or the second control signal. When the temperature of the motherboard is greater than the preset temperature, the fan starts operating. Therefore, the motherboard can save energy.

### FIELD

The subject matter herein generally relates to a motherboard and an electronic device utilizing the motherboard.

### BACKGROUND

A computer usually uses a heat sink and a cooperating fan for heat dissipation.

### BRIEF DESCRIPTION OF THE DRAWINGS

Implementations of the present technology will now be described, by way of example only, with reference to the attached figures.

FIG. 1 is a block diagram of an example embodiment of an electronic device.

FIG. 2 is a circuit diagram of an embodiment of a motherboard of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to a motherboard.

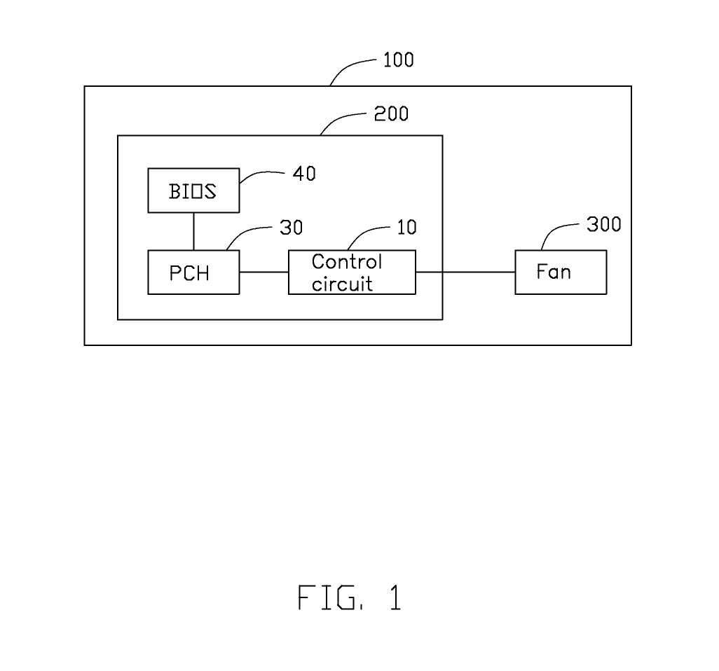

FIG. 1 illustrates a block diagram of an example embodiment of an electronic device 100 including a motherboard 200 and a fan 300. The motherboard 200 includes a control circuit 10, a platform controller hub (PCH) 30, and a basic input output system (BIOS) 40. The control circuit 10 is coupled to the PCH 30 and the fan 300. The PCH 30 is coupled to the BIOS 40. In the embodiment, the electronic device 100 is a computer, such as a desktop computer or a notebook computer.

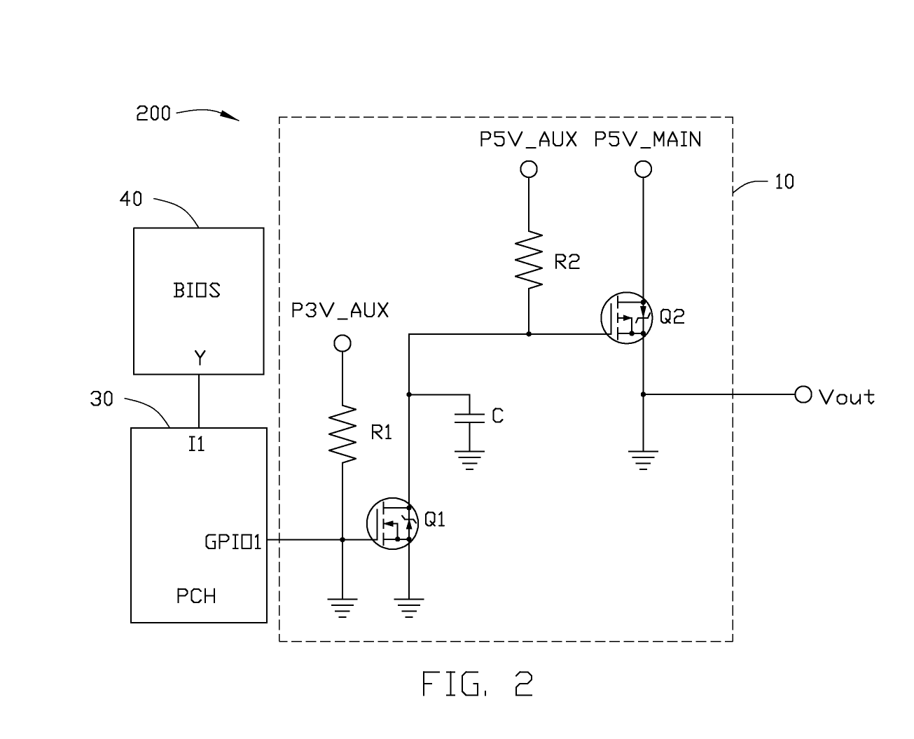

FIG. 2 illustrates a circuit diagram of an embodiment of the motherboard 200 including electronic switches Q1 and Q2, resistors R1 and R2, and a capacitor C. In the embodiment, the electronic switch Q1 is a n-channel metal oxide semiconductor field-effect transistor (MOSFET). The electronic switch Q2 is a p-channel metal oxide semiconductor field-effect transistor (MOSFET). A gate of the electronic switch Q1 is coupled to a basic input and output pin GPIO1 of the PCH 30, and is coupled to a power source terminal P3V_AUX through the resistor R1. A source of the electronic switch Q1 is grounded. A drain of the electronic switch Q1 is coupled to a power source terminal P5V_AUX through the resistor R2, and is grounded through the capacitor C.

A gate of the electronic switch Q2 is coupled to the drain of the electronic switch Q1. A drain of the electronic switch Q2 is coupled to a power source terminal P5V_MAIN. A source of the electronic switch Q2 is grounded and functions as an output terminal Vout of the control circuit 10 coupled to the fan 300.

An input pin I1 of the PCH 30 is coupled to an output pin Y of the BIOS 40. The basic input and output pin GPIO1 of the PCH 30 is coupled to the control circuit 10. A preset temperature is stored in the BIOS 40. The BIOS 40 compares the preset temperature with a temperature of the motherboard 200 output from a temperature sensor and obtains a result, and controls the PCH 30 to output a first control signal or a second control signal according to the result.

In use, when the temperature of the motherboard 200 is less than the preset temperature, the BIOS 40 controls the PCH 30 to output a digital low signal to the gate of the electronic switch Q1. The electronic switch Q1 is turned off. The gate of the electronic switch Q2 receives a voltage from the power source terminal P5V_AUX, and is turned off. The output terminal Vout of the control circuit 10 outputs a digital low signal to the fan 300. The fan 300 stops operating.

When the temperature of the motherboard 200 is greater than the preset temperature, the BIOS 40 controls the PCH 30 to output a digital high signal to the gate of the electronic switch Q1. The electronic switch Q1 is turned on. The gate of the electronic switch Q2 receives a digital low signal, and is turned off. The output terminal Vout of the control circuit 10 outputs a digital high signal to the fan 300. The fan 300 starts operating.

Therefore, when the temperature of the motherboard is less than the preset temperature, a heat sink of the computer 100 carrying out a task of heat dissipation. When the temperature of the motherboard is greater than the preset temperature, the fan 300 starts operating, which can save energy.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A motherboard comprising:
a platform controller hub (PCH);
a basic input and output system (BIOS) storing a preset temperature;
a control circuit comprising
a first electronic switch, wherein a control terminal of the first electronic switch is coupled to a first power source terminal through a first resistor, and is coupled to the PCH for receiving the first control signal or the second control signal;
a first terminal of the first electronic switch is grounded, a second terminal of the first electronic switch is coupled to a second power source terminal through a second resistor;
a second electronic switch, wherein a control terminal of the second electronic switch is coupled to the second terminal of the first electronic switch, a first terminal of the second electronic switch is grounded, and is coupled to a fan;
the second terminal of the first electronic switch is coupled to a third power source; and
wherein when the temperature of the motherboard is greater than the preset temperature, the BIOS controls the PCH to output the first control signal to the control terminal of the first electronic switch, the first and second electronic switches are turned off, a voltage from the third power source terminal is output to the fan through the second resistor, and the fan starts operating.

2. The motherboard of claim 1, wherein the control circuit further comprises a capacitor, the second terminal of the first electronic switch is grounded through the capacitor.

3. The motherboard of claim 2, wherein the first electronic switch is a n-channel metal oxide semiconductor field-effect transistor (MOSFET), the control terminal, the first terminal, and the second terminal of the first electronic switch correspond to a gate, a source, and a drain of the MOSFET, respectively.

4. The motherboard of claim 3, wherein the second electronic switch is a p-channel metal oxide semiconductor field-effect transistor (MOSFET), the control terminal, the first terminal, and the second terminal of the second electronic switch correspond to a gate, a source, and a drain of the MOSFET, respectively.

5. An electronic device comprising a motherboard and a fan, the motherboard comprising:
a platform controller hub (PCH);
a basic input and output system (BIOS) storing a preset temperature;
a control circuit comprising
a first electronic switch, wherein a control terminal of the first electronic switch is coupled to a first power source terminal through a first resistor, and is coupled to the PCH for receiving the first control signal or the second control signal;
a first terminal of the first electronic switch is grounded, a second terminal of the first electronic switch is coupled to a second power source terminal through a second resistor;
a second electronic switch, wherein a control terminal of the second electronic switch is coupled to the second terminal of the first electronic switch, a first terminal of the second electronic switch is grounded, and is coupled to a fan;
the second terminal of the first electronic switch is coupled to a third power source; and
wherein when the temperature of the motherboard is greater than the preset temperature, the BIOS controls the PCH to output the first control signal to the control terminal of the first electronic switch, the first and second electronic switches are turned off, a voltage from the third power source terminal is output to the fan through the second resistor, and the fan starts operating.

6. The electronic device of claim 5, wherein the control circuit further comprises a capacitor, the second terminal of the first electronic switch is grounded through the capacitor.

7. The electronic device of claim 6, wherein the first electronic switch is a n-channel metal oxide semiconductor field-effect transistor (MOSFET), the control terminal, the first terminal, and the second terminal of the first electronic switch correspond to a gate, a source, and a drain of the MOSFET, respectively.

8. The electronic device of claim 7, wherein the second electronic switch is a p-channel metal oxide semiconductor field-effect transistor (MOSFET), the control terminal, the first terminal, and the second terminal of the second electronic switch correspond to a gate, a source, and a drain of the MOSFET, respectively.
